(19) United States
(12) Patent Application Publication
(10) Pub. No.: US 2016/0209268 A1
(43) Pub. Date: Jul. 21, 2016

(54) TERAHERTZ RECEIVER AND TERAHERTZ IMAGING SENSOR APPARATUS FOR HIGH DATA RATE

(71) Applicant: KOREA ADVANCED INSTITUTE OF SCIENCE AND TECHNOLOGY, Yuseong-gu (KR)

(72) Inventors: Sang-Gug LEE, Yuseong-gu (KR); Sun-A KIM, Yuseong-gu (KR); Dae-Woong PARK, Yuseong-gu (KR); Seok-Kyun HAN, Yuseong-gu (KR)

(21) Appl. No.: 14/614,726

(22) Filed: Feb. 5, 2015

(30) Foreign Application Priority Data
Jan. 20, 2015 (KR) 10-2015-0009328

(51) Int. Cl. G01J 1/44

(52) U.S. Cl. CPC G01J 1/44

(57) ABSTRACT

Provided is a terahertz receiver for high data rate including: a detector including a field effect transistor (FET) configured to convert a terahertz wave signal received by a receiving antenna to an electric current; and a measuring device configured to read out an electric current output from the detector.

### CROSS-REFERENCE TO RELATED APPLICATION(S)

This application claims the benefit under 35 U.S.C. §119(a) of Korean Patent Application No. KR 10-2015-0009328, filed on Jan. 20, 2015 in the Korean Intellectual Property Office, the entire disclosure of which is incorporated herein by reference for all purposes.

### BACKGROUND

1. Field

The present invention relates to a terahertz receiver for high data rate which is capable of accurately detecting a high frequency such as a terahertz frequency at a high speed and a terahertz imaging sensor apparatus for high data rate.

2. Description of the Related Art

A terahertz (THz) wave technology of 0.1 to 3 THz range in the electromagnetic spectrum band has a feature of penetrating non-metallic and non-polar materials as well as a feature that resonant frequencies of very various molecules are distributed within the above range. The terahertz wave technology is a high-technology field that is expected to provide a new conceptual analysis technology that has never been in various application fields such as medicals, agricultures, foods, environment measurements, biotechnologies, safeties, and high-tech material evaluations using real-time identification of the molecules by non-destructive, non-opening, and non-contact methods. Further, since the terahertz wave technology has little effect on a human body due to very low energy level of several meV, the terahertz wave technology has been rapidly rising as an essential core technology for realizing an anthropocentric ubiquitous society, and the demands for the terahertz wave technology have been rapidly increasing.

An apparatus for generating/detecting terahertz wave most extensively used so far employs a photomixing method based on Time Domain Spectroscopy (hereinafter, referred to as “TDS”) that generates a terahertz wave by irradiating a femtosecond ultra-short pulse laser on a semiconductor having a high-speed response time. The apparatus for generating/detecting terahertz wave including a femtosecond high power pulse laser and a photomixer has an advantage of providing a high signal to noise ratio (SNR), but essentially requires the femtosecond high power pulse laser and a very delicate optical system. Accordingly, there are many limitations for development into a portable measuring instrument due to high price and great system size.

An apparatus for generating/detecting terahertz wave based on Frequency Domain Spectroscopy (hereinafter, referred to as “FDS”) that have been developed later than the TDS receives new attention as a technology that enables the apparatus to be more portable and commercialized by using two continuous wave diode lasers (LD) of cheap price and small size as an excitation light source instead of a femtosecond high-power laser of expensive price and great size. However, since using various expensive components and delicate packaging technologies, this FDS-based apparatus for generating/detecting terahertz wave is still known as an expensive apparatus used only in laboratories. Recently, various commercialization technologies such as attempts to use a dual-mode tunable LD as an excitation light source and integrate the excitation light source and a photomixer have been studied for portability and cost-saving.

A background technology of the present invention is disclosed in Korean Patent Publication No. 10-2011-0030975 filed on Sep. 18, 2009.

### SUMMARY

In one general aspect, there is provided a terahertz receiver for high data rate including: a detector including a field effect transistor (FET) configured to convert a terahertz wave signal received by a receiving antenna to an electric current; and a measuring device configured to read out an electric current output from the detector.

The measuring device may include a trans-impedance amplifier configured to covert the electric current output from the detector to a voltage and to amplify the electric current.

The measuring device may include a load resistance connected between the detector and a ground; and an input capacitor connected between the detector and the ground, and read out an electric current flowing in the load resistance.

The measuring device may read out the electric current using the following equation.

I=1/(R_{ch}+R_{LI}∥C_{LI})*ΔV*(1/ωC_{LI}/(1/ωC_{LI}+R_{LI}))

Herein, I: Electric current flowing in the load resistance

ΔV: DC output voltage of the transistor generated by a terahertz wave

R_{ch}: Channel resistance between a source and a drain of the transistor

R_{LI}: Load resistance of the measuring device

C_{LI}: Input capacitor of the measuring device

In one general aspect, there is provided a terahertz imaging sensor apparatus for high data rate including: a detector including a field effect transistor (FET) configured to convert a terahertz wave signal received by a receiving antenna to an electric current; a measuring device configured to read out an electric current output from the detector; and a digital signal generating unit configured to generate a digital signal on the basis of an electric current value measured by the measuring device.

The measuring device may include a trans-impedance amplifier configured to convert the electric current output from the detector to a voltage and to amplify the electric current.

The digital signal generating unit may include a voltage-controlled oscillator configured to output an oscillation frequency according to an output voltage of the measuring device.

The digital signal generating unit may include a frequency digital converter configured to convert the oscillation frequency output from the voltage-controlled oscillator to a digital signal.

The terahertz imaging sensor apparatus for high data rate may further include a digital signal processor configured to generate data on the basis of the converted digital signal.

The measuring device may include a load resistance connected between the detector and a ground; and an input capacitor connected between the detector and the ground, and read out an electric current flowing in the load resistance.

The measuring device may read out the electric current using the following equation.

I=1/(R_{ch}+R_{LI}∥C_{LI})*ΔV*(1/ωC_{LI}/(1/ωC_{LI}+R_{LI}))

Herein, I: Electric current flowing in the load resistance
ΔV: DC output voltage of the transistor generated by a terahertz wave
R_{ch}: Channel resistance between a source and a drain of the transistor
R_{LI}: Load resistance of the measuring device
C_{LI}: Input capacitor of the measuring device

### BRIEF DESCRIPTION OF THE DRAWINGS

FIG. 1 is a diagram for describing a terahertz receiver for high data rate according to an embodiment of the present invention.

FIG. 2 is a diagram for describing an equivalent circuit of the terahertz receiver for high data rate according to an embodiment of the present invention.

FIG. 3 is a diagram for describing a terahertz imaging sensor apparatus for high data rate according to an embodiment of the present invention.

FIG. 4 is a diagram for describing a voltage-controlled oscillator according to an embodiment of the present invention.

FIG. 5 is a graph for describing a gain KVCO of the voltage-controlled oscillator.

FIG. 6 is a diagram illustrating the output frequency of the voltage-controlled oscillator of the present invention with time.

FIG. 7 is a diagram for describing a method for driving an imaging sensor apparatus according to an embodiment of the present invention.

### DETAILED DESCRIPTION

Hereinafter, embodiments of the present invention will be described in detail with reference to the accompanying drawings to allow those skilled in the art to easily implement the embodiments. However, the present invention may be implemented in various forms, and is not limited to the embodiments described herein. Further, parts that are not related to the description are not illustrated in the drawings, and similar parts are assigned similar reference numerals throughout the specification.

Throughout the specification, it will be further understood that the terms “comprises,” “comprising,” “includes,” and “including” mean that one part further includes other parts, but do not exclude other parts, unless the context clearly indicates otherwise. Further, the terms “unit,” “device,” and “module” means a unit for processing at least one function or operation, and may implemented by hardware, software, or a combination of hardware and software.

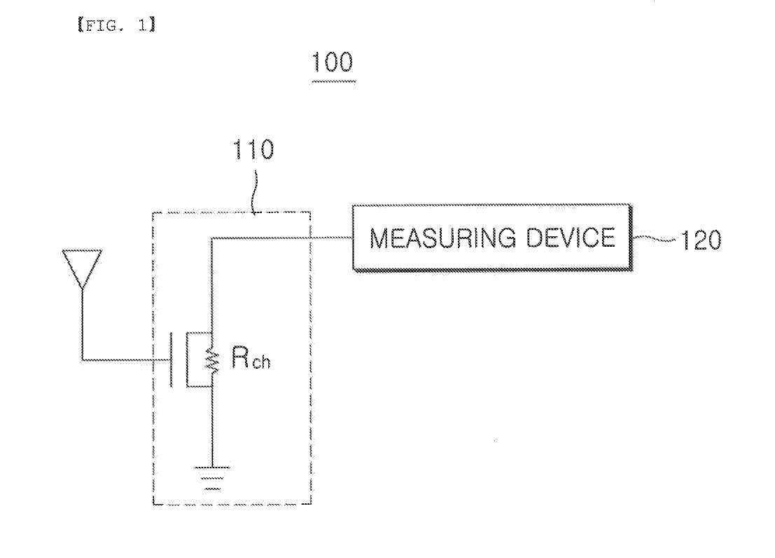

FIG. 1 is a diagram for describing a terahertz receiver for high data rate according to an embodiment of the present invention.

Referring to FIG. 1, a terahertz receiver for high data rate 100 may include a detector 110 and a measuring device 120.

The detector 110 may convert a terahertz wave signal received by a receiving antenna to an electric current. The detector 110 may include a field effect transistor (FET) configured to a terahertz wave signal to an electric current.

The measuring device 120 may read out an electric current output from the detector 110. For example, the measuring device 120 may be realized using a trans-impedance amplifier configured to covert the electric current output from the detector 110 to a voltage and to amplify the electric current. The measuring device 120 can be implemented in other various forms.

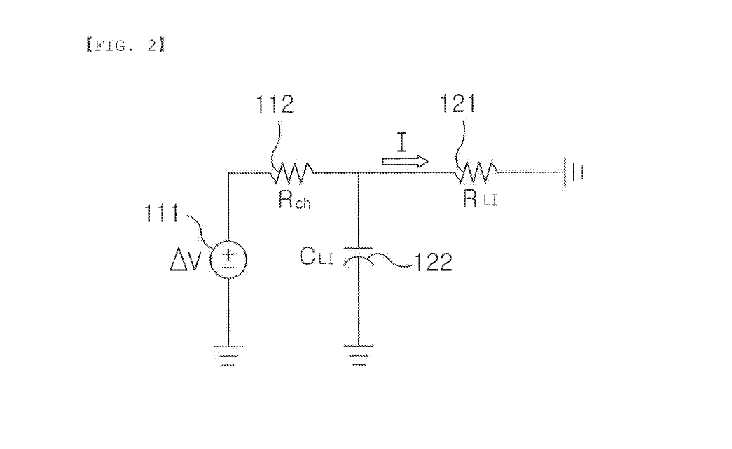

FIG. 2 is a diagram for describing an equivalent circuit of the terahertz receiver for high data rate according to an embodiment of the present invention.

Referring to FIG. 2, the terahertz receiver for high data rate 100 may include the detector 110 and the measuring device 120.

The detector 110 may be expressed by an equivalent circuit such as a DC output voltage (ΔV) 111 of the transistor generated by a terahertz wave and a channel resistance (R_{ch}) 112 between a source and a drain of the transistor.

The measuring device 120 may be expressed by an equivalent circuit such as a load resistance (R_{LI}) 121 connected between the detector 110 and a ground and an input capacitor (C_{LI}) 122 connected between the detector 110 and the ground.

The measuring device 120 may read out an electric current flowing in the load resistance 121 using the following equation.

I=1/(R_{ch}+R_{LI}∥C_{LI})*ΔV*(1/ωC_{LI}/(1/ωC_{LI}+R_{LI}))

Herein, I: Electric current flowing in the load resistance
ΔV: DC output voltage of the transistor generated by a terahertz wave
R_{ch}: Channel resistance between a source and a drain of the transistor
R_{LI}: Load resistance of the measuring device
C_{LI}: Input capacitor of the measuring device

In order to transfer the DC output voltage (ΔV) of the transistor generated by a terahertz wave as much as possible, the load resistance (R_{LI}) 121 and the input capacitor (C_{LI}) use small values. For example, the load resistance (R_{LI}) 121 may use 1 K, and the input capacitor (C_{LI}) 122 may use 10 fF. When a modulation frequency value increases, an impedance value of the input capacitor (C_{LI}) decreases. If the input capacitor (C_{LI}) 122 is 10 fF, a relationship between the modulation frequency and the impedance value of the input capacitor (C_{LI}) can be expressed as listed in the following Table 1.

TABLE 1

| Modulation | Impedance of Input |
|---|---|
| Frequency (HZ) | Capacitor (C_{LI}) |
| 1M | 15.9M |
| 10M | 1.59M |
| 100M | 159K |
| 1G | 15.9K |
| 10G | 1.59K |

Referring to the above equation, since the load resistance (R_{LI}) 121 of the measuring device 120 has a small value, an electric current value to be measured does not greatly change even if the impedance value of the input capacitor (C_{LI}) fluctuates according to the modulation frequency. That is, there is a small change in reactivity. Therefore, the measuring device 120 according to the present invention is suitable for broadband terahertz communication.

With the terahertz receiver for high data rate, a change in reactivity can be small by reducing a change in impedance of the capacitor according to a change in modulation frequency.

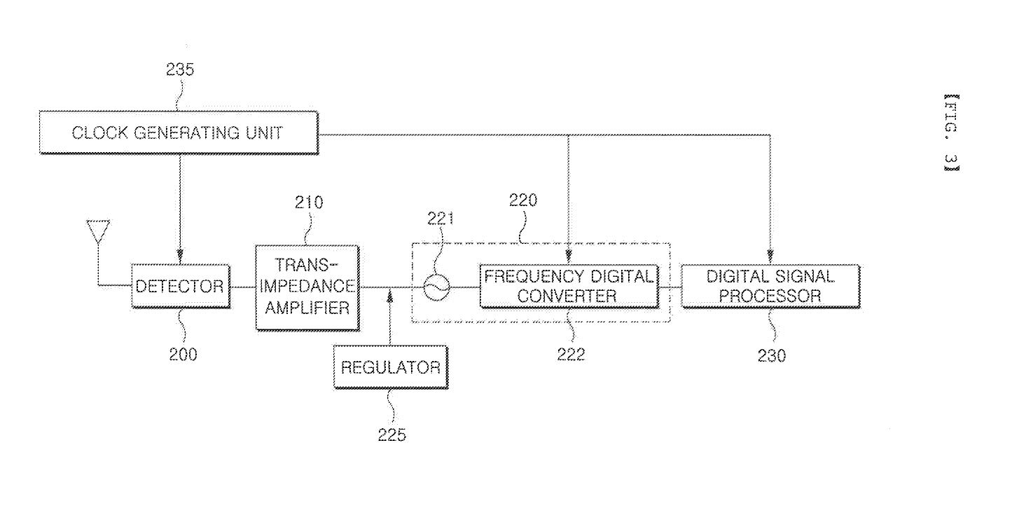

FIG. 3 is a diagram for describing a terahertz imaging sensor apparatus for high data rate according to an embodiment of the present invention.

Referring to FIG. 3, a terahertz imaging sensor apparatus for high data rate may include a detector 200, a measuring device 210, a digital signal generating unit 220, a regulator 225, a digital signal processor 230, and a clock generating unit 235.

The detector 200 may convert a terahertz wave signal received by a receiving antenna to an electric current. The detector 200 may include a field effect transistor (FET) configured to a terahertz wave signal to an electric current.

The measuring device 210 may read out an electric current output from the detector 200. For example, the measuring device 210 may be realized using a trans-impedance amplifier configured to covert the electric current output from the detector 200 to a voltage and to amplify the electric current.

The measuring device 210 may read out an electric current flowing in a load resistance using the following equation described in FIG. 1.

A voltage-controlled oscillator 221 is configured to output an oscillation frequency according to an output voltage of the trans-impedance amplifier 210.

A frequency digital converter 222 is configured to convert the oscillation frequency output from the voltage-controlled oscillator 221 to a digital signal. The frequency digital converter 222 may be realized using, for example, a counter.

The regulator 225 is configured to regulate a gain of the voltage-controlled oscillator 221 by regulating the output voltage applied to the voltage-controlled oscillator 221. The gain (KVCO) of the voltage-controlled oscillator 221 may be a value of (frequency control range)/(voltage control range).

The regulator 225 is configured to regulate the output voltage applied to the voltage-controlled oscillator 221 to raise the gain of the voltage-controlled oscillator 221 when it is necessary to increase output sensitivity according to the state of the system. Thus, since a change of an output frequency of the voltage-controlled oscillator 221 is increased even though a change of the output voltage is small, the output sensitivity is increased.

On the other hand, the regulator 225 is configured to regulate the output voltage applied to the voltage-controlled oscillator 221 to lower the gain of the voltage-controlled oscillator 221 when it is necessary to reduce noise sensitivity. Thus, since the change of the output frequency of the voltage-controlled oscillator 221 is not large even though the change of the output voltage is small, the output does not sensitively respond to noise.

The output voltage may be manually regulated by a user, or may be automatically regulated by an algorithm.

The digital signal processor 230 is configured to generate data on the basis of the converted digital signal.

The clock generating unit 235 is configured to generate clocks for operations of circuits included in a focal plane array imaging device, and to control operation timings of the respective circuits.

For example, when it is assumed that a single set (“corresponding to a single pixel”) includes a receiving antenna and the detector 200, the clock generating unit 235 may input a first control signal and a second control signal to the detector 200 for a time during which the single set is operated. Here, the first control signal is a signal that allows a DC output current by the received terahertz wave to be generated, and the second control signal is a signal that does not allow the DC output current by the received terahertz wave to be generated. Here, a power is constantly applied to a detector 130 for the operating time, the first control signal means a signal that controls the detector 130 to generate the DC output current by the received terahertz wave, and the second control signal means a signal that controls the detector not to generate the DC output current by the received terahertz wave. For example, when the detector 130 is the field effect transistor, a first control voltage and a second control voltage may be bias voltages. The operating time means a time taken to turn off a set corresponding to a single pixel from turning on the set. The operating time is referred to as a scanning time.

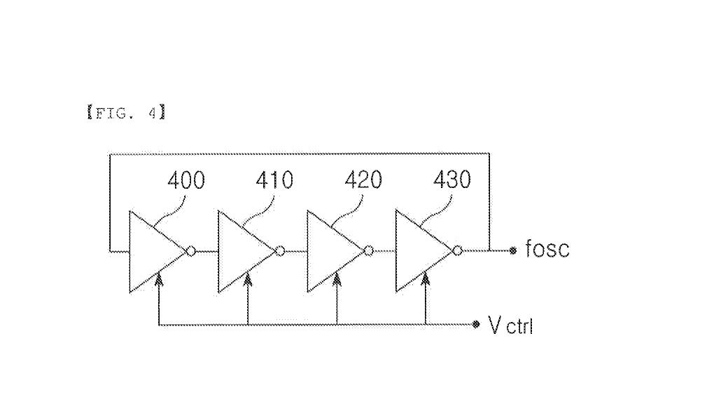

FIG. 4 is a diagram for describing a voltage-controlled oscillator according to an embodiment of the present invention.

Referring to FIG. 4, the voltage-controlled oscillator may be a ring voltage-controlled oscillator realized as a ring form in which a plurality of delay cells is connected in series. The delay cell may be realized using, for example, inverters 400, 410, 420 and 430 or a differential delay cell.

The delay cell is realized so as to control a RC time constant by controlling a current by an applied voltage.

Thus, the voltage-controlled oscillator including the plurality of delay cells receives an output voltage Vctrl of the detector to output an oscillation frequency f_{OSC}.

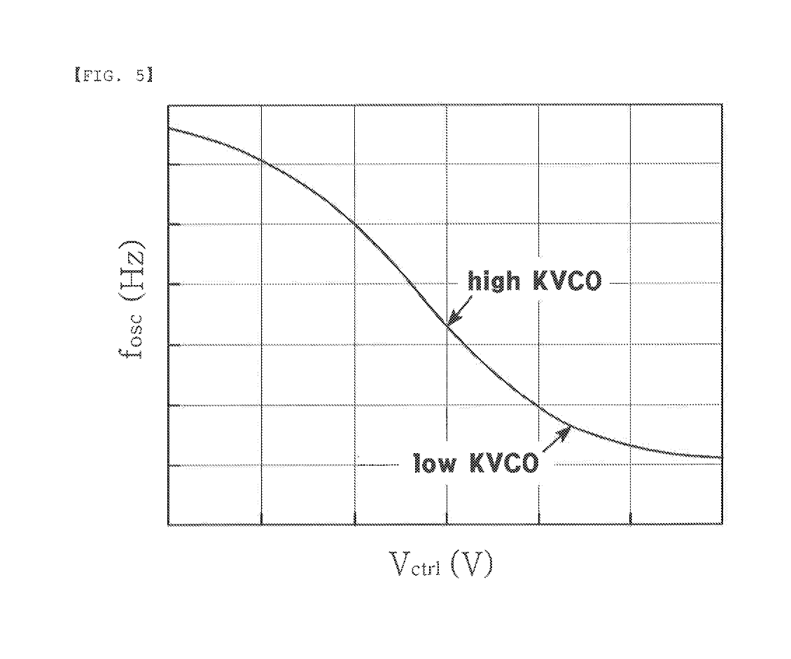

FIG. 5 is a graph for describing a gain KVCO of the voltage-controlled oscillator.

FIG. 5 illustrates a curved line of an output frequency f_{OSC} with a control voltage Vctrl of the voltage-controlled oscillator. The gain KVCO of the voltage-controlled oscillator is a value of (frequency control range)/(voltage control range).

Accordingly, an incline of the curved line of FIG. 3 is a value of the gain KVCO of the voltage-controlled oscillator with respect to the control voltage Vctrl according to definition of the gain KVCO of the voltage-controlled oscillator. A portion where the incline of the curved line is high is a high KVCO portion, and a portion where the incline of the curved line is low is a low KVCO portion.

When the state of the system needs to increase output sensitivity, the output voltage applied to the voltage-controlled oscillator can be regulated (the output voltage can be moved to the High KVCO portion) so as to raise the gain of the voltage-controlled oscillator.

Meanwhile, when it is necessary to reduce the noise sensitivity, the output voltage applied to the voltage-controlled oscillator can be regulated (the output voltage can be moved to the low KVCO portion) so as to lower the gain of the voltage-controlled oscillator.

In this way, the voltage-controlled oscillator can output the oscillation frequency in an optimal state by regulating the output voltage to be suitable for the state of the system.

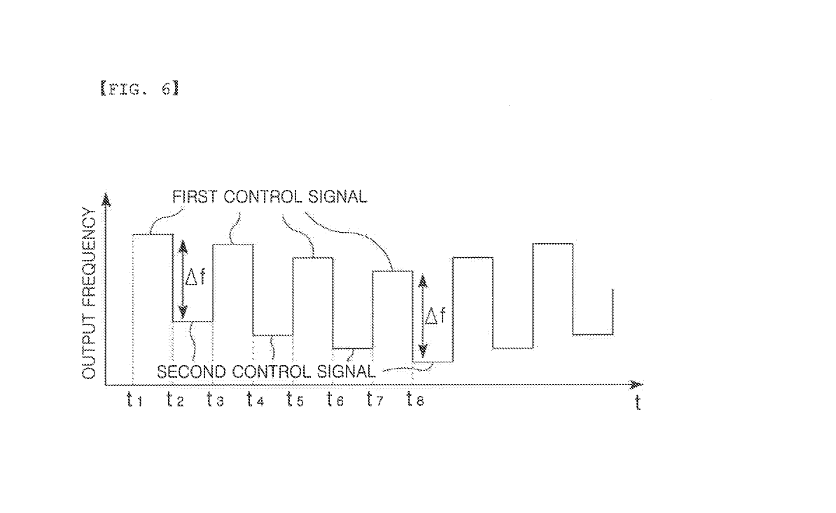

FIG. 6 is a diagram illustrating the output frequency of the voltage-controlled oscillation of the present invention with time.

A horizontal axis of the graph illustrated in FIG. 6 represents a time, and a vertical axis thereof represents the output frequency generated in the voltage-controlled oscillator.

Referring to FIGS. 5 and 6, when the first control signal is input in times such as t1, t3, t5 and t7, or when the second control signal is input in times such as t2, t4, t6 and t8, absolute values of frequencies output from the voltage-controlled oscillator are not constant. As mentioned above, the reason why the output frequencies of the voltage-controlled oscillator are not constant is because of frequency drift.

The digital signal processor according to the present invention does not use the absolute values of the frequencies output from the voltage-controlled oscillator, and uses the difference value ‘Δf’ between the first oscillation frequency generated in the voltage-controlled oscillator while the first control signal is input to the detector and the second oscillation frequency generated in the voltage-controlled oscillator while the second control signal is input. Accordingly, it is possible to remove noise due to the frequency drift. Here, the Δf may be a difference value between the output frequencies generated by the difference value ΔV between the applied voltage when the first control signal is input and the applied voltage when the second control signal is input.

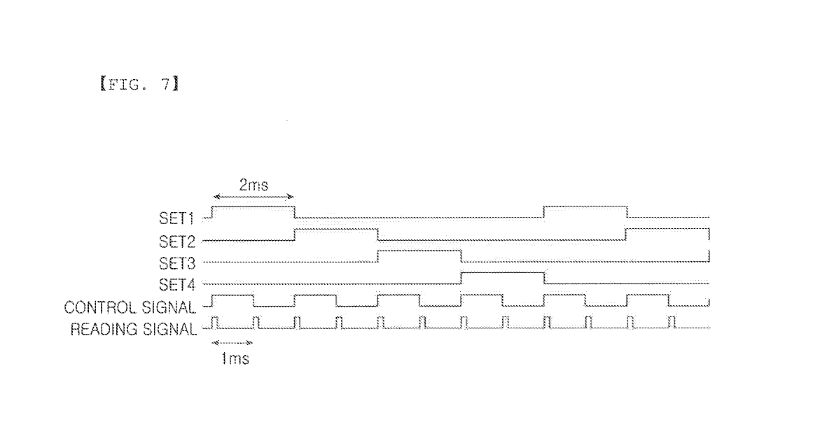

FIG. 7 is a diagram for describing a method for driving an imaging sensor apparatus according to an embodiment of the present invention.

A case where the imaging sensor apparatus includes four pixels and four sets (each having the receiving antenna and the detector) corresponding to the four pixels exist will be described below. However, the number of pixels included in the imaging sensor apparatus is not limited to the number described above, and may be variously implemented.

Referring to FIGS. 3 and 7, driving signals may be sequentially applied to a set 1, a set 2, a set 3 and a set 4. For example, the respective driving signals may be applied for 2 ms.

The clock generating unit 235 may generate the first control signal and the second control signal for a time during which the set 1, the set 2, the set 3 and the set 4 are operated to input the generated first and second control signals to the detector 200. Here, the first control signal is a signal that allows the DC output voltage by the received terahertz wave to be generated, and the second control signal is a signal that does not allow the DC output voltage by the received terahertz wave to be generated. The first control signal and the second control signal are respectively applied for 1 ms.

The digital signal processor 230 may read the first oscillation frequency generated in the voltage-controlled oscillator 221 while the first control signal is input to the detector, and may read the second oscillation frequency generated in the voltage-controlled oscillator while the second control signal is input to the detector. For example, the digital signal processor 230 may read the first oscillation frequency generated in the voltage-controlled oscillator 221 within “1 ms” during which the first control signal is input (“a reading signal”), and may read the second oscillation frequency generated in the voltage-controlled oscillator 221 within “1 ms” during which the second control signal is input (“a reading signal”). That is, the digital signal processor 230 may read the oscillation frequency every reading signal (“1 ms”).

For example, when the first control signal or the second control signal is input to the detector and disappears, or when the reading signal is input, the digital signal processor 230 may read the oscillation frequency generated for last “1 ms”. Specifically, the frequency digital converter 222 may read the oscillation frequency generated in the voltage-controlled oscillator 221 for last “1 ms”, and the digital signal processor 230 may read the oscillation frequency signal generated in the frequency digital converter 222.

For example, the digital signal processor 230 may calculate the difference value Δf between the first oscillation frequency and the second oscillation frequency every falling edge of the driving signal applied to the set.

The digital signal processor 230 may generate data on the basis of the difference value between the read first and second oscillation frequencies.

The described embodiments may be implemented by selectively combining all or a part of the embodiments so as to allow the embodiments to be variously modified.

Furthermore, the embodiments are for the purpose of describing particular embodiments only and are not intended to be limiting of the present invention. In addition, it is to be appreciated to those skilled in the art that various embodiments are possible without departing from the technical spirit of the present invention.

### EXPLANATION OF REFERENCE NUMERALS

100: Terahertz receiver for high data rate
111: DC output voltage of transistor
112: Channel resistance
110: Detector
120: Measuring device
121: Load resistance
122: Input capacitor
200: Detector
210: Measuring device
220: Digital signal generating unit
225: Regulator
230: Digital signal processor
235: Clock generating unit

What is claimed is:

1. A terahertz receiver for high data rate comprising:
a detector including a field effect transistor (FET) configured to convert a terahertz wave signal received by a receiving antenna to an electric current; and
a measuring device configured to read out an electric current output from the detector.

2. The terahertz receiver for high data rate of claim 1, wherein the measuring device includes a trans-impedance amplifier configured to covert the electric current output from the detector to a voltage and to amplify the electric current.

3. The terahertz receiver for high data rate of claim 1, wherein the measuring device includes:
a load resistance connected between the detector and a ground; and
an input capacitor connected between the detector and the ground, and
reads out an electric current flowing in the load resistance.

4. The terahertz receiver for high data rate of claim 3, wherein the measuring device reads out the electric current using the following equation:
I=1/(R_{ch}+R_{LI}∥C_{LI})*ΔV*(1/ωC_{LI}/(1/ωC_{LI}+R_{LI}))
wherein I: electric current flowing in the load resistance
ΔV: DC output voltage of the transistor generated by a terahertz wave
R_{ch}: channel resistance between a source and a drain of the transistor
R_{LI}: load resistance of the measuring device
C_{LI}: input capacitor of the measuring device.

5. A terahertz imaging sensor apparatus for high data rate comprising:
a detector including a field effect transistor (FET) configured to convert a terahertz wave signal received by a receiving antenna to an electric current;
a measuring device configured to read out an electric current output from the detector; and
a digital signal generating unit configured to generate a digital signal on the basis of an electric current value measured by the measuring device.

6. The terahertz imaging sensor apparatus for high data rate of claim 5, wherein the measuring device includes a trans-impedance amplifier configured to convert the electric current output from the detector to a voltage and to amplify the electric current.

7. The terahertz imaging sensor apparatus for high data rate of claim 6, wherein the digital signal generating unit includes a voltage-controlled oscillator configured to output an oscillation frequency according to an output voltage of the measuring device.

8. The terahertz imaging sensor apparatus for high data rate of claim 7, wherein the digital signal generating unit includes a frequency digital converter configured to convert the oscillation frequency output from the voltage-controlled oscillator to a digital signal.

9. The terahertz imaging sensor apparatus for high data rate of claim 8, further comprising:
a digital signal processor configured to generate data on the basis of the converted digital signal.

10. The terahertz imaging sensor apparatus for high data rate of claim 7, further comprising:
a regulator configured to be able to regulate a gain of the voltage-control oscillator by regulating the output voltage applied to the voltage-control oscillator.

11. The terahertz imaging sensor apparatus for high data rate of claim 10, wherein the regulator is configured to regulate the output voltage of the measuring device to raise the gain of the voltage-control oscillator when it is necessary to increase output sensitivity, and to regulate the output voltage to lower the gain of the voltage-control oscillator when it is necessary to reduce noise sensitivity.

12. The terahertz imaging sensor apparatus for high data rate of claim 10, wherein the gain of the voltage-control oscillator is a value of (frequency control range)/(voltage control range).

13. The terahertz imaging sensor apparatus for high data rate of claim 8, further comprising:
a clock generating unit configured to input, to the detector, a first control signal which allows a DC output voltage by the received terahertz wave to be generated and a second control signal which does not allow the DC output voltage by the received terahertz wave to be generated for a time during which a set having the receiving antenna and the detector is operated; and
a digital signal processor configured to generate data on the basis of a difference value between a first oscillation frequency generated by the voltage-controlled oscillator while the first control signal is input to the detector and a second oscillating frequency generated by the voltage-controlled oscillator while the second control signal is input to the detector.

14. The terahertz imaging sensor apparatus for high data rate of claim 5, wherein measuring device includes:
a load resistance connected between the detector and a ground; and
an input capacitor connected between the detector and the ground, and
reads out an electric current flowing in the load resistance.

15. The terahertz imaging sensor apparatus for high data rate of claim 14, wherein the measuring device reads out the electric current using the following equation:
I=1/(R_{ch}+R_{LI}∥C_{LI})*ΔV*(1/ωC_{LI}/(1/ωC_{LI}+R_{LI}))
wherein I: electric current flowing in the load resistance
ΔV: DC output voltage of the transistor generated by a terahertz wave
R_{ch}: channel resistance between a source and a drain of the transistor
R_{LI}: load resistance of the measuring device
C_{LI}: input capacitor of the measuring device.
